(19) United States
(12) Patent Application Publication
(10) Pub. No.: US 2024/0169345 A1
(43) Pub. Date: May 23, 2024

(54) SYSTEMS AND METHODS FOR ENHANCING DIGITAL WALLET SECURITY

(71) Applicant: JPMORGAN CHASE BANK, N.A., New York, NY (US)

(72) Inventors: Jai CHAWLA, Livingston, NJ (US); Dipti AHUJA, Basking Ridge, NJ (US); Reetu BOK, Philadelphia, PA (US); Gerardo GEAN, Plano, TX (US); Maurice SHORROSH, New York, NY (US)

(21) Appl. No.: 18/056,645

(22) Filed: Nov. 17, 2022

(51) Int. Cl. G06Q 20/36; G06Q 20/40

(52) U.S. Cl. CPC G06Q 20/3674; G06Q 20/401

(57) ABSTRACT

Systems and methods for enhancing digital wallet security are disclosed. In one embodiment, a method may include a service provider computer program: (1) receiving a request from a computer program executed by a user electronic device for user authentication with a product identifier for a product; (2) generating a verification code; (3) communicating the product identifier and the verification code to a verification computer program, wherein the verification computer program is configured to retrieve user contact information for a user associated with the product identifier and communicate the verification code to the user electronic device; (4) receiving, by the service provider computer program, a received verification code from the computer program, wherein the received verification code was received at the user electronic device; and (5) communicating authorization for an action involving the product to the computer program in response to the received verification code matching the verification code.

### BACKGROUND OF THE INVENTION

### 1. Field of the Invention

Embodiments generally relate to systems and methods for enhancing digital wallet security.

### 2. Description of the Related Art

It is not uncommon for an individual to not update contact information with merchants or wallet application providers. Because of this, when a user wishes to add a banking product, such as a credit card, to a digital wallet, or store it for card on file transactions, the merchant or wallet provider may not be able to send a verification message to the user. This leads to users giving up or having to update their contact information before again trying to add the banking product to the digital wallet.

### SUMMARY OF THE INVENTION

Systems and methods for enhancing digital wallet security are disclosed. In one embodiment, a method for enhancing digital wallet security may include: (1) receiving, at a service provider computer program executed by a service provider electronic device, a request from a computer program executed by a user electronic device for user authentication with a product identifier for a product; (2) generating, by the service provider computer program, a verification code; (3) communicating, by the service provider computer program, the product identifier and the verification code to a verification computer program executed by a backend associated with a provider of the product identifier, wherein the verification computer program is configured to retrieve user contact information for a user associated with the product identifier and communicate the verification code to the user electronic device; (4) receiving, by the service provider computer program, a received verification code from the computer program, wherein the received verification code was received at the user electronic device; and (5) communicating, by the service provider computer program, authorization for an action involving the product to the computer program in response to the received verification code matching the verification code.

In one embodiment, the method may also include communicating, by the service provider computer program, denial for the action involving the product to the computer program in response to the received verification code not matching the verification code.

In one embodiment, the product may include a banking product, and the action may include adding the banking product to a digital wallet application executed by the user electronic device.

In one embodiment, the method may also include receiving, by the service provider computer program, an identification of a communication channel to send the verification code to the user electronic device; and communicating, by the service provider computer program, the identification of the communication channel to the verification computer program, wherein the verification computer program is configured communicate the verification code to the user electronic device over the communication channel.

In one embodiment, the verification code may be communicated to the user electronic device by short messaging service, electronic mail, or in-app messaging.

According to another embodiment, a method for enhancing digital wallet security may include: (1) receiving, by a verification computer program executed by a backend associated with a provider of a product and from a service provider computer program, a request to authenticate a user comprising a product identifier for the product; (2) retrieving, by the verification computer program, user contact information associated with the product identifier; (3) communicating, by the verification computer program, a request for authenticating information to the user contact information; (4) receiving, by the verification computer program, received authenticating information; (5) retrieving, by the verification computer program, stored authenticating information for the user associated with the product identifier; and (6) communicating, by the verification computer program and to the service provider computer program, authorization for an action involving the product in response to the received authenticating information matching the stored authenticating information.

In one embodiment, the method may also include communicating, by the verification computer program and to the service provider computer program, denial for the action involving the product to the computer program in response to the received authenticating information not matching the stored authenticating information.

In one embodiment, the product may be a banking product, and the action may include adding the banking product to a digital wallet application executed by a user electronic device.

In one embodiment, the authenticating information may include a personal identification number or a card verification value for the banking product, a driver's license number for the user, out of wallet information for the user, etc.

In one embodiment, the method may also include receiving, by the verification computer program and from the service provider computer program, an identification of a communication channel to send the request for authenticating information; and communicating, by the verification computer program, the request for authenticating information over the communication channel.

In one embodiment, the request for authenticating information may be communicated by short messaging service, electronic mail, or in-app messaging.

According to another embodiment, a system may include: a user electronic device executing a user computer program; a service provider electronic device executing a service provider computer program; and a backend executing a verification computer program. The user computer program submits a request to add a product associated with a product identifier to the user computer program to the service provider computer program. The service provider computer program submits a request to authenticate a user associated with the product identifier to the verification computer program. The verification computer program retrieves user contact information associated with the product identifier, communicates a request for authenticating information to the user electronic device using the user contact information; receives received authenticating information from the user electronic device; retrieves stored authenticating information for the user associated with the product identifier; and communicates authorization for an action involving the product to the service provider in response to the received authenticating information matching the stored authenticating information.

In one embodiment, the verification computer program may communicate no authorization for the action involving the product to the computer program to the service provider in response to the received authenticating information matching the stored authenticating information.

In one embodiment, the product may be a banking product, and the action may include adding the banking product to a digital wallet application executed by a user electronic device.

In one embodiment, the authenticating information may include a personal identification number or a card verification value for the banking product, a driver's license number for the user, out of wallet information for the user, etc.

In one embodiment, the user electronic device may also execute a computer program associated with the backend, and the verification computer program communicates the request for authenticating information to the computer program associated with the backend, and the computer program associated with the backend communicates the received authenticating information to the verification computer program.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for enhancing digital wallet security according to an embodiment.

FIG. 2 depicts a method for enhancing digital wallet security according to one embodiment.

FIG. 3 depicts a method for enhancing digital wallet security according to another embodiment.

FIG. 4 depicts a method for enhancing digital wallet security according to another embodiment.

FIG. 5 depicts an exemplary computing system for implementing aspects of the present disclosure.

### DETAILED DESCRIPTION OF PREFERRED EMBODIMENTS

Embodiments are directed to systems and methods for enhancing digital wallet security.

Embodiments may leverage a financial institution's knowledge of a customer in order to validate or verify a customer.

In embodiments, when a customer seeks to add a banking product, such as a credit card, to a third-party digital wallet, the third-party digital wallet may request that a service provider (e.g., a payment network operator) generate a verification code, such as a one-time passcode, and provide the verification code to a financial institution that is associated with the banking product. Because the financial institution may be required to maintain contacts for its customers, the financial institution may send the verification code to contact information for the user from a customer profile that the financial institution maintains for the user. The user may optionally be presented with an option to select a communication channel (e.g., text/SMS), voice (e.g. interactive voice response system), email, in-application, etc.) over which the verification may be sent. Alternatively, the channel may be selected by default (e.g., always text), may rotate among registered channels for the user (e.g., email—text— phone—in-app, etc.), may be selected randomly, etc.

The financial institution may then retrieve contact information for the selected channel, and may send the verification code to the user over the selected communication channel. The user may then enter the verification code into the user interface for the digital wallet, and the digital wallet may provide the verification code to the service provider for verification. If the verification code is validated, the banking product may be added to the digital wallet. If the verification code is not validated, the banking product is not added to the digital wallet.

In embodiments, the financial institution backend may perform the validation directly using, for example, a verification code, confirmation of an issued card feature confirmation (e.g., last four digits, expiration date, a card verification value (CVV), a personal identification number (PIN), etc.), identification information (e.g., a driver's license number or a portion thereof, driver's license expiration date, etc.), out of wallet information verification, or in-application verification using the financial institution's application (e.g., biometric entry, code entry, etc.). Thus, the financial institution may provide “verification as a service” using the contact information that it maintains for its customers.

Thus, users need not keep their contact information current with the merchants or third-party wallet providers.

Embodiments may thereby reduce friction in the digital wallet user journey while enhancing the overall security of the digital wallet.

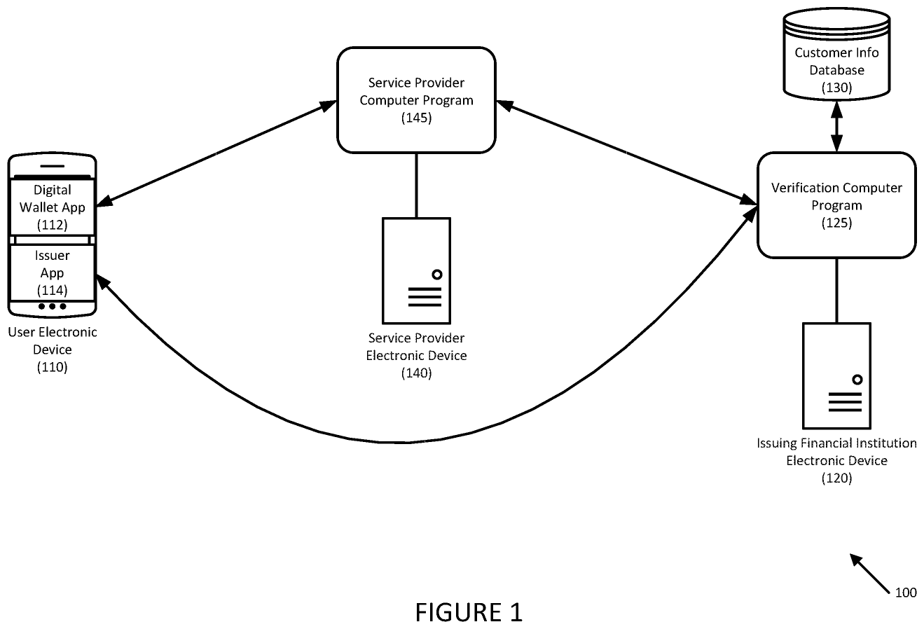

Referring to FIG. 1, a system for enhancing digital wallet security is disclosed according to an embodiment. System 100 may include user electronic device 110, which may be any suitable electronic device, such as a computer (e.g., workstation, desktop, notebook, laptop, tablet, etc.), smart devices (e.g., smartphones, smartwatches, etc.) Internet of Things (IoT) appliances, etc. User electronic device 110 may execute one or more computer programs or applications, including, for example, digital wallet application 112 and issuer application 114.

In one embodiment, electronic wallet application may be provided by a third-party wallet provider, a merchant, etc. In one embodiment, the user of user electronic device 110 may add a banking product, such as a credit card, a debit card, etc., to digital wallet application 112.

Digital wallet application 112 may communicate with service provider computer program 145 that may be executed by service provider electronic device 140. Service provider may be, for example, a payment network operator, such as VISA, MASTERCARD, AMERICAN EXPRESS, or any private label (e.g., closed loop) payment networks.

Digital wallet application 112 may communicate with service provider computer program 145 using any suitable network, including, for example, the payment network associated with the service provider. Service provider computer program 145 may also communicate with verification computer program 125 using any suitable network, including, for example, the payment network associated with the service provider.

Issuer application 114 may communicate with verification computer program 125, which may be executed by issuing financial institution electronic device 120. The issuing financial institution may be the financial institution that issued the banking product being added to digital wallet application 112. It should be noted that more than one issuing financial institution may be provided, with each executing its own verification computer program.

Verification computer program 125 may communicate with user electronic device 110, including issuer app 114, a messaging app (not shown), a phone app (not shown), an email app (not shown) etc., using any suitable communication channel or networks, including cellular network, the Internet, etc. For example, verification computer program 125 may communicate with electronic device 110 and/or including issuer app 114 by email, text (e.g., SMS) messaging, voice, in-app communication, etc.

The issuing financial institution may maintain customer information database 130 that may maintain contact information for its customers, including phone numbers, SMS addresses, email address, issuer app identifiers, etc. In one embodiment, customer information database 130 may maintain, directly or indirectly, a mapping of bank products to customer profiles.

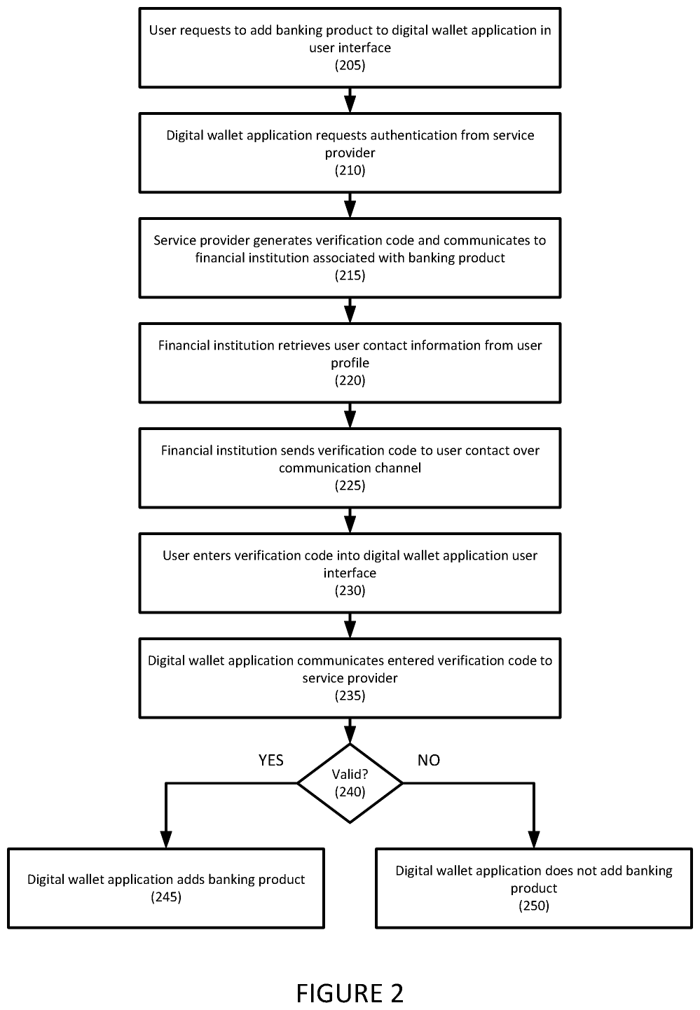

Referring to FIG. 2, a method for enhancing digital wallet security is disclosed according to an embodiment.

In step 205, a user may access a digital wallet application that is executed on a user electronic device and, in a user interface for the digital wallet application, may request to add a banking product, such as a credit card, a debit card, a demand deposit account (DDA), a line of credit, a rewards account, etc. to the digital wallet. In one embodiment, the user may enter a banking product identifier, such as a credit card number, may enter an account number, may capture an image of the banking product and the digital wallet application may identify the banking product identifier from the image, etc. In one embodiment, the digital wallet application may use the wireless capabilities of the electronic device (e.g., near field communication) to receive the banking product identifier.

In one embodiment, the user may optionally select a communication channel to receive a verification code on, such as text/SMS, email, voice, in-application messaging, etc.

In step 210, the digital wallet application, or a backend therefore, may request user authentication from a service provider. The digital wallet application may provide the banking product identifier to the service provider and the communication channel identified by the user, if provided.

In step 215, a service provider computer program may generate a verification code, such as a random alphanumeric code. The verification code may have any suitable number of digit and/or characters.

In one embodiment, the service provider computer program may identify a financial institution that is associated with the banking product, such as an issuer, from the banking product identifier. For example, the service provider computer program may identify the financial institution from, for example, a bank identification number, a routing number, or a user identification of the financial institution.

The service provider computer program may then communicate the verification code and the banking product identifier to the financial institution. If provided, the service provider computer program may also communicate the communication channel for the verification code that was identified by the user.

In step 220, a financial institution computer program executed by the financial institution, such as a verification computer program, may retrieve user contact information for the banking product identifier from, for example, a user profile in a customer information database. The user contact information may include a SMS address, an email address, an identifier for a financial institution mobile application, etc.

In step 225, the financial institution computer program may send the verification code to the user electronic device. In one embodiment, if provided, the financial institution computer program may use the communication channel identified by the user.

Alternatively, the financial institution computer program may randomly select the communication channel, may select the communication channel that was most recently updated, may select the communication channel that has successfully been used before, etc.

In step 230, the user electronic device may receive the verification code, and the user may enter the verification code into the digital wallet application user interface. In one embodiment, the operating system for the user electronic device may pre-populate the user interface with the verification code.

In step 235, the digital wallet application or a backend therefore may communicate the entered verification code to the service provider.

In step 240, the service provider may validate the verification code. If the verification code is valid (e.g., matches the verification code generated by the service provider), in step 245, it may authorize the digital wallet application to add the banking product. If the verification code is not valid (e.g., does not match the verification code generated by the service provider or is not received within a certain period of time), in step 250, it may instruct the digital wallet application to not add the banking product.

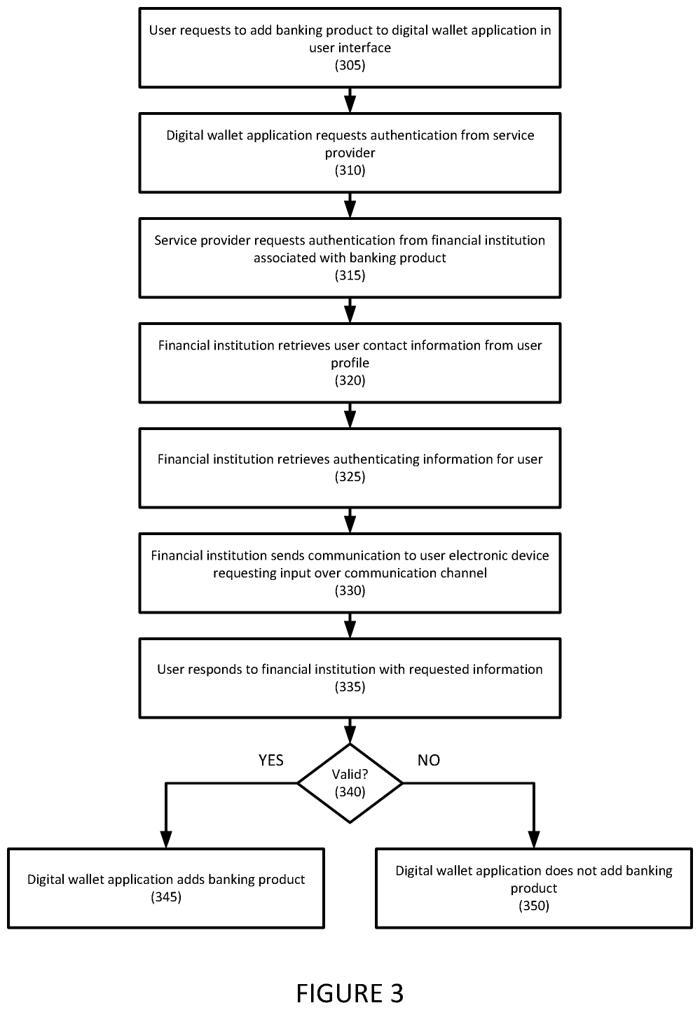

Referring to FIG. 3, a method for enhancing digital wallet security is disclosed according to an embodiment.

In step 305, a user may access a digital wallet application that is executed on a user electronic device and, in a user interface for the digital wallet application, may request to add a banking product, such as a credit card, a debit card, a demand deposit account (DDA), a line of credit, a rewards account, etc. to the digital wallet. In one embodiment, the user may enter a banking product identifier, such as a credit card number, may enter an account number, may capture an image of the banking product and the digital wallet application may identify the banking product identifier from the image, etc. In one embodiment, the digital wallet application may use the wireless capabilities of the electronic device (e.g., near field communication) to receive the banking product identifier.

In one embodiment, the user may optionally select a communication channel to receive a verification code on, such as text/SMS, email, voice, in-application messaging, etc.

In step 310, the digital wallet application, or a back end therefore, may request user authentication from a service provider. The digital wallet application may provide the banking product identifier to the service provider and the communication channel identified by the user, if provided.

In step 315, a service provider computer program may identify a financial institution that is associated with the banking product, such as an issuer, from the banking product identifier. For example, the service provider computer program may identify the financial institution from, for example, a bank identification number, a routing number, or a user identification of the financial institution.

The service provider computer program may then submit a request for authentication and the banking product identifier to the financial institution. If provided, the service provider computer program may also communicate the communication channel for the verification code that was identified by the user.

In step 320, a financial institution computer program executed by the financial institution, such as a verification computer program, may retrieve user contact information for the banking product identifier from, for example, a user profile in a customer information database. The user contact information may include a SMS address, and email address, an identifier for a financial institution mobile application, etc.

In step 325, the financial institution computer program may retrieve authenticating information for the banking product identifier from, for example, a user profile in a customer information database.

Authenticating information may include, for example, information for the bank product, such as a CVV or PIN for the bank product, or information for the user, such as the user's driver's license number or expiration date, the user's social security number, the user's home ZIP code, etc. In another embodiment, authenticating information may include a challenge that may be based, for example, on the user's current location, a challenge phrase and a response, out-of-wallet information out of wallet answers (e.g., first car, favorite food, high school mascot, etc.), etc. Any suitable authenticating information may be used as is necessary and/or desired.

In another embodiment, the financial institution computer program may use biometric authentication conducted by the financial institution application and the electronic device operating system.

In step 330, the financial institution computer program may send a communication to the user electronic device requesting an input. For example, the financial institution computer program may request that the user provide information related to the information retrieved from the user profile, such as the PIN, the CVV, information for the user, etc.

As another example, the financial institution computer program may request biometric authentication from the user using the financial institution application.

In one embodiment, the communication channel may be the communication channel identified by the user. For some embodiments, such as biometric authentication, the in-app communication channel may be selected.

Alternatively, the financial institution computer program may randomly select the communication channel, may select the communication channel that was most recently updated, may select the communication channel that has successfully been used before, etc.

In one embodiment, the communication channel may be selected based on the sensitivity of the information requested. For example, if a CVV, PIN, or personal identifiable information (e.g., some or all of a driver's license number or a social security number) are to be requested, in-app messaging or other secure communication may be used.

In step 335, the user may respond to the financial institution with requested information. In one embodiment, the user may respond using the same communication channel over which the request was received, such as text/SMS, email, voice, in-app, etc.

In step 340, the financial institution computer program may validate the user input. If the user input is valid (e.g., it matches the information requested), in step 345, the financial institution computer program may authorize the digital wallet application directly or indirectly (e.g., through the service provider computer program and/or the financial institution app) to add the bank product. If the user input is not valid (e.g., does not match the or is not received within a certain period of time), in step 350, the financial institution computer program may instruct the digital wallet application, directly or indirectly, to not add the banking product.

In one embodiment, the user may have more than one opportunity to enter the correct information.

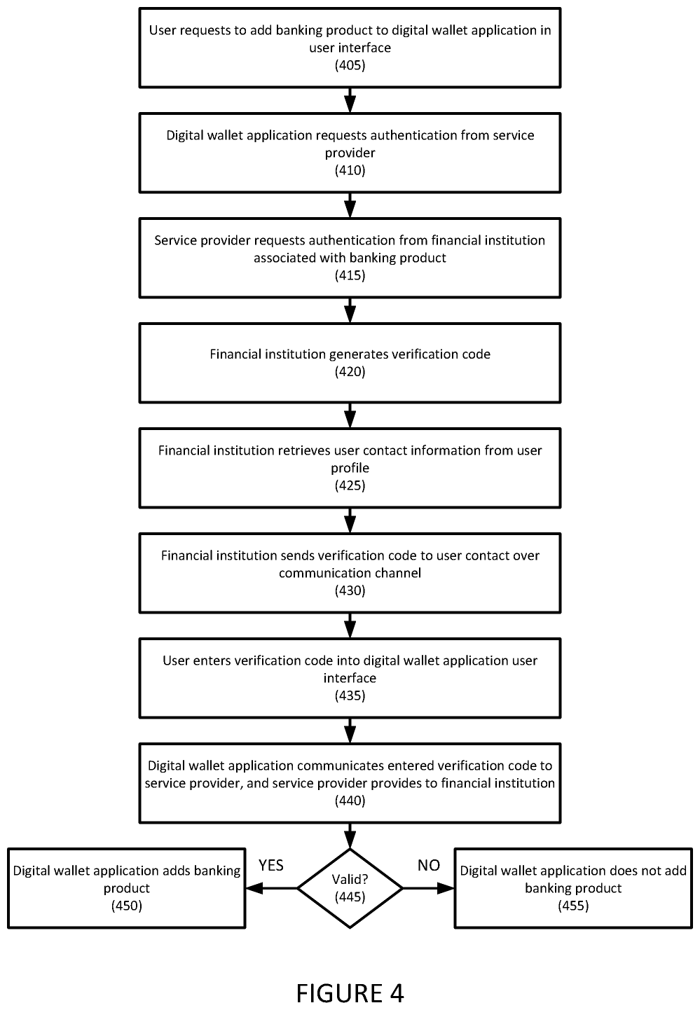

FIG. 4 depicts method for enhancing digital wallet security according to another embodiment.

In step 405, a user may access a digital wallet application that is executed on a user electronic device and, in a user interface for the digital wallet application, may request to add a banking product, such as a credit card, a debit card, a demand deposit account (DDA), a line of credit, a rewards account, etc. to the digital wallet. In one embodiment, the user may enter a banking product identifier, such as a credit card number, may enter an account number, may capture an image of the banking product and the digital wallet application may identify the banking product identifier from the image, etc. In one embodiment, the digital wallet application may use the wireless capabilities of the electronic device (e.g., near field communication) to receive the banking product identifier.

In one embodiment, the user may optionally select a communication channel to receive a verification code on, such as text/SMS, email, voice, in-application messaging, etc.

In step 410, the digital wallet application, or a back end therefore, may request user authentication from a service provider. The digital wallet application may provide the banking product identifier to the service provider and the communication channel identified by the user, if provided.

In step 415, the service provider computer program may identify a financial institution that is associated with the banking product, such as an issuer, from the banking product identifier. For example, the service provider computer program may identify the financial institution from, for example, a bank identification number, a routing number, or a user identification of the financial institution.

The service provider computer program may then submit a request for authentication and the banking product identifier to the financial institution. If provided, the service provider computer program may also communicate the communication channel for the verification code that was identified by the user.

In step 420, a financial institution computer program executed by the financial institution, such as a verification computer program, may generate a verification code, such as a random alphanumeric code. The verification code may have any suitable number of digits and/or characters.

Alternatively, the service provider computer program may generate and provide the verification code to the financial institution computer program, and the financial institution computer program may use that verification code to authenticate the user.

In step 425, the financial institution computer program may retrieve user contact information for the banking product identifier from, for example, a user profile in a customer information database. The user contact information may include a SMS address, and email address, an identifier for a financial institution mobile application, etc.

In step 430, the financial institution computer program may send the verification code to the user electronic device. In one embodiment, if provided, the financial institution computer program may use the communication channel identified by the user.

Alternatively, the financial institution computer program may randomly select the communication channel, may select the communication channel that was most recently updated, may select the communication channel that has successfully been used before, etc.

In step 435, the user electronic device may receive the verification code, and the user may enter the verification code into the digital wallet application user interface. In one embodiment, the operating system for the user electronic device may pre-populate the user interface with the verification code.

In another embodiment, the user may enter the verification code to an application associated with the financial institution, such as an issuer application.

In step 440, the digital wallet application may communicate the entered verification code to the service provider, and the service provider may then provide the entered verification code to the financial institution.

In one embodiment, if the user enters the verification code into the application that is associated with the financial institution, the application may provide the verification code to the financial institution without involving the service provider.

In step 445, the financial institution computer program may validate the verification code. If the verification code is valid (e.g., matches the verification code generated by the financial institution computer program), in step 450, the financial institution computer program may authorize the digital wallet application to add the banking product. In one embodiment, this may be done by informing the service provider that the authentication was successful, and the service provider may then authorize the digital wallet to add the banking product. In another embodiment, the financial institution computer program may inform the application that is associated with the financial institution, and the application may inform the digital wallet application of the successful authentication by app-to-app communication.

If the verification code is not valid (e.g., does not match the verification code generated by the financial institution computer program or is not received within a certain period of time), in step 455, the financial institution computer program may instruct the digital wallet application to not add the banking product. This may also be achieved by informing the service provider or the application associated with the financial institution that authentication was unsuccessful.

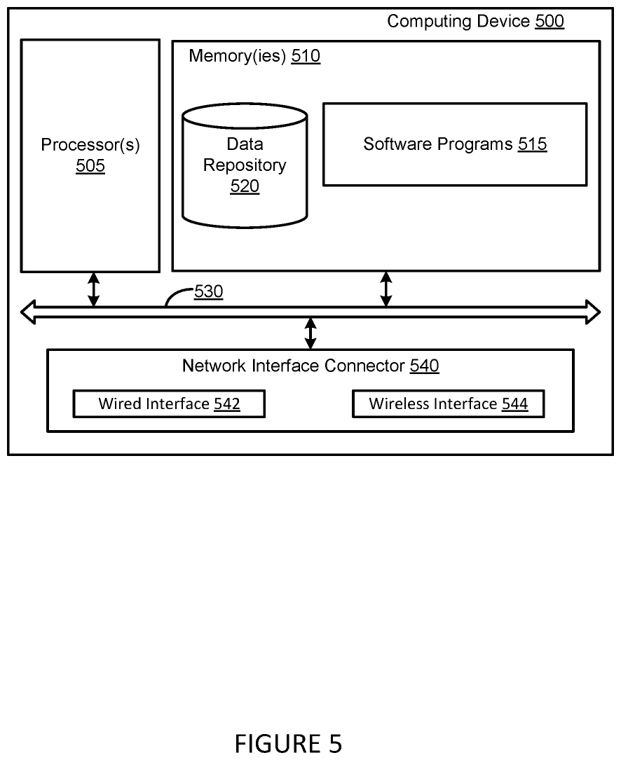

FIG. 5 depicts an exemplary computing system for implementing aspects of the present disclosure. FIG. 5 depicts exemplary computing device 500. Computing device 500 may represent the system components described herein. Computing device 500 may include processor 505 that may be coupled to memory 510. Memory 510 may include volatile memory. Processor 505 may execute computer-executable program code stored in memory 510, such as software programs 515. Software programs 515 may include one or more of the logical steps disclosed herein as a programmatic instruction, which may be executed by processor 505. Memory 510 may also include data repository 520, which may be nonvolatile memory for data persistence. Processor 505 and memory 510 may be coupled by bus 530. Bus 530 may also be coupled to one or more network interface connectors 540, such as wired network interface 542 or wireless network interface 544. Computing device 500 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for enhancing digital wallet security, comprising:
receiving, at a service provider computer program executed by a service provider electronic device, a request from a computer program executed by a user electronic device for user authentication with a product identifier for a product;
generating, by the service provider computer program, a verification code;
communicating, by the service provider computer program, the product identifier and the verification code to a verification computer program executed by a backend associated with a provider of the product identifier, wherein the verification computer program is configured to retrieve user contact information for a user associated with the product identifier and communicate the verification code to the user electronic device;
receiving, by the service provider computer program, a received verification code from the computer program, wherein the received verification code was received at the user electronic device; and
communicating, by the service provider computer program, authorization for an action involving the product to the computer program in response to the received verification code matching the verification code.

2. The method of claim 1, further comprising:
communicating, by the service provider computer program, denial for the action involving the product to the computer program in response to the received verification code not matching the verification code.

3. The method of claim 1, wherein the product comprises a banking product, and the action comprises adding the banking product to a digital wallet application executed by the user electronic device.

4. The method of claim 1, further comprising:
receiving, by the service provider computer program, an identification of a communication channel to send the verification code to the user electronic device; and
communicating, by the service provider computer program, the identification of the communication channel to the verification computer program, wherein the verification computer program is configured communicate the verification code to the user electronic device over the communication channel.

5. The method of claim 1, wherein the verification code is communicated to the user electronic device by short messaging service, electronic mail, voice communication, or in-app messaging.

6. A method for enhancing digital wallet security, comprising:
receiving, by a verification computer program executed by a backend associated with a provider of a product and from a service provider computer program, a request to authenticate a user comprising a product identifier for the product;
retrieving, by the verification computer program, user contact information associated with the product identifier;
communicating, by the verification computer program, a request for authenticating information to the user contact information;
receiving, by the verification computer program, received authenticating information;
retrieving, by the verification computer program, stored authenticating information for the user associated with the product identifier; and
communicating, by the verification computer program and to the service provider computer program, authorization for an action involving the product in response to the received authenticating information matching the stored authenticating information.

7. The method of claim 6, further comprising:
communicating, by the verification computer program and to the service provider computer program, denial for the action involving the product to the computer program in response to the received authenticating information not matching the stored authenticating information.

8. The method of claim 6, wherein the product comprises a banking product, and the action comprises adding the banking product to a digital wallet application executed by a user electronic device.

9. The method of claim 8, wherein the authenticating information comprises a personal identification number or a card verification value for the banking product.

10. The method of claim 6, wherein the authenticating information comprises a driver's license number for the user.

11. The method of claim 6, wherein the authenticating information comprises out of wallet information for the user.

12. The method of claim 6, further comprising:
receiving, by the verification computer program and from the service provider computer program, an identification of a communication channel to send the request for authenticating information; and
communicating, by the verification computer program, the request for authenticating information over the communication channel.

13. The method of claim 6, wherein the request for authenticating information is communicated by short messaging service, electronic mail, or in-app messaging.

14. A system, comprising:
a user electronic device executing a user computer program;
a service provider electronic device executing a service provider computer program; and
a backend executing a verification computer program;
wherein:
the user computer program submits a request to add a product associated with a product identifier to the user computer program to the service provider computer program;
the service provider computer program submits a request to authenticate a user associated with the product identifier to the verification computer program;
the verification computer program retrieves user contact information associated with the product identifier;
the verification computer program communicates a request for authenticating information to the user electronic device using the user contact information;
the verification computer program receives received authenticating information from the user electronic device;
the verification computer program retrieves stored authenticating information for the user associated with the product identifier; and
the verification computer program communicates authorization for an action involving the product to the service provider in response to the received authenticating information matching the stored authenticating information.

15. The system of claim 14, wherein the verification computer program communicates no authorization for the action involving the product to the computer program to the service provider in response to the received authenticating information matching the stored authenticating information.

16. The system of claim 14, wherein the product comprises a banking product, the user computer program comprises a digital wallet application, and the action comprises adding the banking product to the digital wallet application.

17. The system of claim 16, wherein the authenticating information comprises a personal identification number or a card verification value for the banking product.

18. The system of claim 14, wherein the authenticating information comprises a driver's license number for the user.

19. The system of claim 14, wherein the authenticating information comprises out of wallet information for the user.

20. The system of claim 14, wherein the user electronic device further executes a computer program associated with the backend, and the verification computer program communicates the request for authenticating information to the computer program associated with the backend, and the computer program associated with the backend communicates the received authenticating information to the verification computer program.
